(19) United States
(12) Patent Application Publication
(10) Pub. No.: US 2007/0028973 A1
(43) Pub. Date: Feb. 8, 2007

(54) Directional control valve block

(75) Inventors: Yoshinobu Kobayashi, Tsuchiura-shi (JP); Katsumi Ueno, Tsuchiura-shi (JP); Rindou Morikawa, Tsuchiura-shi (JP); Hiroshi Matsuzaki, Tsuchiura-shi (JP); Kinya Takahashi, Tsuchiura-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Construction Machinery Co., Ltd., Tokyo (JP)

(21) Appl. No.: 10/566,994

(22) PCT Filed: Aug. 2, 2004
(86) PCT No.: PCT/JP04/11383

§ 371 Date: Sep. 14, 2006

(30) Foreign Application Priority Data
Aug. 4, 2003 (JP) 2003-285897

(51) Int. Cl. F15B 13/04

(52) U.S. Cl. 137/625.69

(57) ABSTRACT

A plurality of directional control valves are included in a valve main body 1. Each of the directional control valves is provided with a spool 2, actuator ports 3,4, a communication passage 7, a parallel passage 6, a tandem passage 5, a first check valve 8 for permitting a flow of pressure fluid from the parallel passage 6 toward the communication passage 7, and a second check valve 9 for permitting a flow of pressure fluid from the tandem passage 5 toward the communication passage 7. For example, the first check valve 8 is slidably arranged in the second check valve 9, the second check valve 9 is provided with a through-hole 14 formed in communication with the communication passage 7, and a plug 11 is arranged in threaded engagement with the valve main body 1 such that an end portion of the first check valve 8 and an end portion of the second check valve 9 are covered by the plug 11.

### TECHNICAL FIELD

This invention relates to a directional control valve block, which includes a plurality of directional control valves in a valve main body and is to be arranged in a hydraulic drive system or the like for a hydraulic excavator.

### BACKGROUND ART

As a conventional technology of this type, a directional control valve block shown in FIG. 3 has been proposed. One of plural directional control valves included in the directional control valve block, that is, a directional control valve 30 depicted in FIG. 3 is provided, in a valve main body 31, with a slidable spool 32, a pair of actuator ports 33,34, a communication passage 37 communicable to the actuator port 34, a communication passage 38 communicable to the actuator port 33, a parallel passage 36 connecting the plural directional control valves, which are included in the directional control valve block, in parallel with each other, and a tandem passage 35 connecting the plural directional control valves, which are included in the directional control valve block, in series with each other.

Also provided are a guide pipe 39 arranged extending such that the guide pipe cuts off the tandem passage 35 and the parallel passage 36 from each other, a first check valve 41 slidably fitted on an outer peripheral portion of the guide pipe 39 for permitting a flow of pressure fluid from the parallel passage 36 toward the communication passage 37 and preventing any flow of pressure fluid in an opposite direction, a second check valve 42 slidably accommodated within an enlarged diameter portion 40 formed in an upper part of the guide pipe 39 and coaxially arranged with the first check valve 41 for permitting a flow of pressure fluid from the tandem passage 35 toward the communication passage 38 and preventing any flow of pressure fluid in an opposite direction, a spring for biasing said first check valve 41, a spring 43 for biasing the second check valve 42, and a plug 44 arranged in threaded engagement with the valve main body 31 such that an end portion of the second check valve 42 and the enlarged diameter portion 40 of the guide pipe 39 are covered by the plug.

It is to be noted that a hydraulic actuator to be driven and controlled by the directional control valve 30 is, for example, a cylinder 45, its bottom chamber 46 is connected to the actuator port 33, and its rod chamber 47 is connected to the actuator port 34 (see, for example, JP 6-12121 B).

When the above-described directional control valve 30 shown in FIG. 3 is switched, for example, to cause the spool 32 to slide in a rightward direction in FIG. 3, the tandem passage 35 is closed so that the parallel passage 36 is rendered communicable to the actuator port 34 via the first check valve 41 and the communication passage 37. Pressure fluid to be fed from an unillustrated pump to the parallel passage 36 lifts the first check valve 41, enters the communication passage 37, and is then fed from the actuator port 34 to the rod chamber 47 of the cylinder 45. As a result, the cylinder 45 retracts.

When the directional control valve is switched to cause the spool 32 to slide in a leftward direction in FIG. 3, the tandem passage 35 is rendered communicable to the actuator port 33 via the interior of the guide pipe 39, the second check valve 42 and the communication passage 38. Pressure fluid to be fed from the unillustrated pump to the tandem passage 35 lifts the second check valve 42, enters the communication passage 38, and is then fed from the actuator port 33 to the bottom chamber 46 of the cylinder 45. As a result, the cylinder 45 extends.

### DISCLOSURE OF THE INVENTION

To the first check valve 41 and second check valve 42 included in the above-mentioned directional control valve 30, heat treatment has been applied to harden their metal surfaces because they slide at the metal surfaces. It is, however, difficult to secure sufficiently large thickness dimensions for these first check valve 41 and second check valve 42. As a consequence, there is a concern about the above-mentioned conventional technology that distortions or cracks may be produced on or in the first check valve 41 and second check valve 42 upon heat treatment, leading to a potential problem that their yields are prone to reductions.

For example, the inner diameter of the first check valve 41 is restricted by the outer diameter of the guide pipe 39, and the outer diameter of the first check valve 41 is restricted by the plug 44. If it is attempted to reduce the inner diameter of the first check valve 41 such that the first check valve would be surely provided with a large thickness dimension, the outer diameter of the guide pipe 39 will become smaller and as a consequence, the inner diameter of the guide pipe 39 will also become smaller. If the inner diameter of the guide pipe 39 would become smaller as mentioned above, the interior of the guide pipe 39, specifically the flow passage of pressure fluid through the guide pipe 39 will be reduced in cross-sectional area so that the operational response of the cylinder 45 upon switching the directional control valve 30 will be deteriorated. Certain degrees of restrictions are, therefore, imposed on the inner and outer diameters of the guide pipe 39 and the inner diameter of the first check valve 41 in order to surely provide them with their functions as desired.

If it is attempted to enlarge the outer diameter of the first check valve 41 such that the first check valve would be securely provided with a large thickness, the outer diameter of the enlarged diameter portion 40 of the guide pipe 39, said enlarged diameter portion 40 serving to limit movements of the first check valve 41, will also have to be enlarged, leading to an enlargement in the size of the plug 44. If the size of the plug 44 becomes greater as mentioned above, the valve main body 31 will also become greater. An enlargement in the size of the valve main body 31 in turn leads to a reduction in the layout space around the directional control block, thereby making it difficult to design the layout of peripheral hydraulic equipment and the like. Certain degrees of restrictions are, therefore, imposed on the outer diameter of the enlarged diameter portion 40 of the guide pipe 39 and the outer diameter of the first check valve 41 in order to avoid any substantial enlargement of the valve main body 31.

With the conventional technology shown in FIG. 3, it is hence impossible to secure a large thickness dimension for the first check valve 41 as mentioned above.

This also applies equally to the thickness dimension of the second check valve 42. The outer diameter of the second check valve 42 can be hardly enlarged, as it is accommodated within the enlarged diameter portion 40 of the guide pipe 39. An enlargement in the outer diameter of the second check valve 42 leads to an increase in the outer diameter of the enlarged diameter portion 40 of the guide pipe 39. As a consequence, the plug 44 becomes large as mentioned above, leading to an enlargement in the valve main body 31. For the reasons mentioned above, it is also difficult to increase the thickness dimension of the second check valve 42.

With the foregoing circumstances of the conventional technology in view, the present invention has as an object the provision of a directional control valve block in which a first check valve and a second check valve included in each directional control valve can be arranged within a valve main body without needing any guide pipe.

To achieve the above-described object, the present invention is characterized in that in a directional control valve block comprising plural directional control valves in a valve main body, each of said directional control valves being provided with a slidable spool, a pair of actuator ports, a communication passage communicable to the actuator ports, a parallel passage connecting the plural directional control valves in parallel with each other, a tandem passage connecting the plural directional control valves in series with each other, a first check valve for permitting a flow of pressure fluid from the parallel passage toward the communication passage and preventing any flow of pressure fluid in an opposite direction, and a second check valve arranged coaxially with the first check valve for permitting a flow of pressure fluid from the tandem passage toward the communication passage and preventing any flow of pressure fluid in an opposite direction, one of the first check valve and the second check valve is slidably arranged in the other.

According to the present invention constructed as described above, when the directional control valve is switched in a predetermined one direction such that the spool is caused to slide and pressure fluid is fed through the parallel passage, the first check valve is caused to slide. As a result, the pressure fluid is fed from the parallel passage to the corresponding actuator port via the first check valve and the communication passage. During this time, the second check valve remains prevented from sliding. As a consequence, the tandem passage remains closed. When the directional control valve is switched in a predetermined other direction such that the spool is caused to slid in the opposite direction and pressure fluid is fed through the tandem passage, the second check valve is caused to slide. As a result, the pressure fluid is fed from the tandem passage to the corresponding actuator port via the second check valve and the communication passage.

Accordingly, the first check valve and second check valve can be arranged in the valve main body without needing any guide pipe which has heretofore been arranged, and further, these first check valve and second check valve can be caused to operate as desired by pressure fluid introduced via the parallel passage or the tandem passage.

The present invention can also be characterized in that in the above-described invention, the parallel passage may be formed at a position on a side opposite the spool with the communication passage being interposed therebetween.

The present invention can also be characterized in that in the above-described invention, the first check valve may be slidably arranged in the second check valve, the second check valve may be provided with a through-hole formed in communication with the communication passage, and a plug may be arranged in threaded engagement with the valve main body such that an end portion of the first check valve and an end portion of the second check valve are covered by the plug.

The present invention can also be characterized in that in the above-described invention, the second check valve may be slidably arranged in the first check valve, and a plug may be arranged in threaded engagement with the valve main body such that an end portion of the first check valve and an end portion of the second check valve are covered by the plug.

According to the present invention, the first check valve and second check valve included in each directional control valve can be arranged in the valve main body without needing a guide pipe. Accordingly, a part of the interior of the valve main body 1, which has heretofore been used as a layout space for a guide pipe, can be used for securing thickness dimensions for the first check valve and second check valve. As a consequence, the thickness dimension of the first check valve and the thickness dimension of the second check valve can be set greater than the conventional technology, thereby making it possible to render the first check valve and second check valve resistant to distortion and cracking upon their heat treatment and hence to improve their yields over the conventional technology.

As no guide pipe is required, it is also possible to decrease the number of parts and hence, to reduce the manufacturing cost.

### BRIEF DESCRIPTION OF THE DRAWINGS

FIG. 1 is a cross-sectional view showing the construction of a first embodiment of the directional control valve block according to the present invention.

FIG. 2 is a cross-sectional view showing the construction of a second embodiment according to the present invention.

FIG. 3 is a cross-sectional view showing the construction of a conventional directional control valve block.

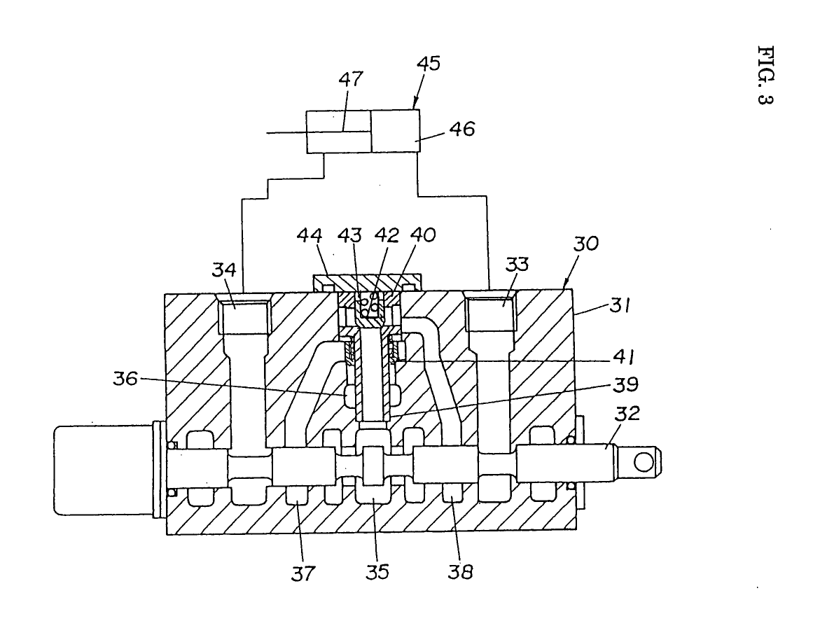

### BEST MODES FOR CARRYING OUT THE INVENTION

Best modes for carrying out the directional control valve block according to the present invention will hereinafter be described based on the drawings.

### First Embodiment

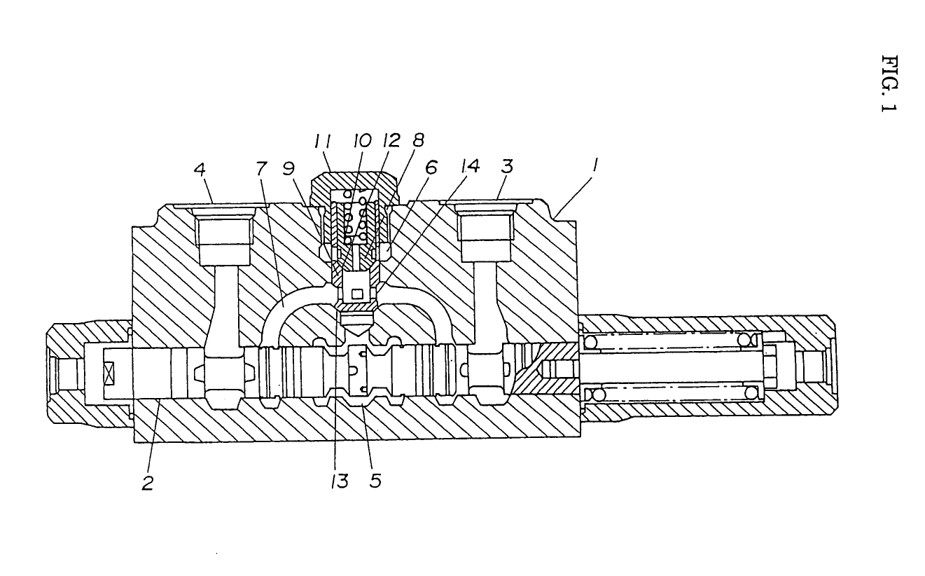

FIG. 1 is a cross-sectional view showing the construction of a first embodiment according to the present invention. This first embodiment can be arranged, for example, in a hydraulic drive system of a hydraulic excavator, and includes a plurality of directional control valves in a valve main body 1.

As illustrated in FIG. 1, the directional control valves are each provided with a slidable spool 2, a pair of actuator ports 3,4, a communication passage 7 communicable to these actuator ports 3,4, a parallel passage 6 connecting the plural directional control valves in parallel with each other in the directional control valve block, and a tandem passage 5 connecting the plural directional control valves in series with each other in the directional control valve block. The above-mentioned parallel passage 6 is formed at a position on a side opposite the spool 2 with the communication passage 7 being interposed therebetween, in other words, at a position on an upper side of the communication passage 7 shown in FIG. 1.

In particular, this first embodiment is not provided with any guide pipe which would otherwise be needed to guide a first check valve 8 and a second check valve 9, and one of the first check valve 8 and second check valve 9 is slidably arranged in the other. For example, the first check valve 8 is slidably and moreover, coaxially arranged in the second check valve 9. In the second check valve 9, a through-hole 14 is formed in communication with the communication passage 7. In the first check valve 8, a spring 10 is arranged to bias the first check valve 8 and the second check valve 9. By this spring 10, the first check valve 8 and second check valve 9 are normally maintained in contact with a seat portion 12 of the second check valve 9 and a seat portion 13 formed on the valve main body 1, and therefore, seal the corresponding seat portions 12,13.

Further, a plug 11 is arranged in threaded engagement with the valve main body 1 such that the plug covers an end portion of the first check valve 8, an end portion of the second check valve 9, and the spring 10.

It is to be noted that the actuator port 3 is connected to a hydraulic actuator, for example, a bottom chamber of a hydraulic cylinder and the actuator port 4 is connected to a rod chamber of the hydraulic cylinder, although their illustrations are omitted in FIG. 1.

When the directional control valve is switched, for example, to cause the spool 2 to slide in the rightward direction of FIG. 1, the communication passage 7 and the actuator port 3 are cut off from each other. When pressure fluid is fed from an unillustrated pump to the parallel passage 6 in this state, the first check valve 8 is caused to move, specifically to slide relative to the second check valve 9 in an upward direction of FIG. 1 against the force of the spring 10. The pressure fluid then enters from a clearance, which has been formed at the seat portion 12 of the second check valve 9, into the interior of the second check valve 9, flows out from the through-hole 14 of the second check valve 9 into the communication passage 7, and further, is fed to the actuator port 4. During this time, the second check valve 9 remains pressed against the seat portion 13 of the valve main body 1 by the pressure fluid fed into the interior of the second check valve 9 and the communication passage 7. Accordingly, the tandem passage 5 remains closed.

When the pressure fluid is fed to the tandem passage 5 in the state that the spool 2 has been caused to slide in the rightward direction as mentioned above, the second check valve 9 is caused to move together with the first check valve 8 in the upward direction of FIG. 1 against the force of the spring 10. In other words, the second check valve 9 slides relative to the inner peripheral portion of the plug 11. Therefore, the pressure fluid in the tandem passage 5 flows out from a clearance, which has been formed at the seat portion 13 of the valve main body 1, into the communication passage 7, and further, is fed to the actuator port 4.

Operations substantially similar to those mentioned above are also performed when the directional control valve is switched to cause the spool 1 to slide in a leftward direction of FIG. 1.

According to the first embodiment constructed as described above, the first check valve 8 is slidably arranged in the second check valve 9, and therefore, these first check valve 8 and second check valve 9 can be arranged in the valve main body 1 without needing such guide pipes as arranged in the conventional technology. Apart of the valve main body 1, which has heretofore been used as a layout space for a guide pipe, can, therefore, be used for securing thickness dimensions for the first check valve 8 and second check valve 9. As a consequence, the thickness dimension of the first check valve 8 and the thickness dimension of the second check valve 9 can be set relatively large. Upon heat treatment of the first check valve 8 and second check valve 9 with their thickness dimensions set relatively large as mentioned above, the first check valve 8 and second check valve 9 are resistant to distortion and cracking, thereby making it possible to improve their yields. It is also possible to reduce the manufacturing cost as no guide pipe is required.

### Second Embodiment

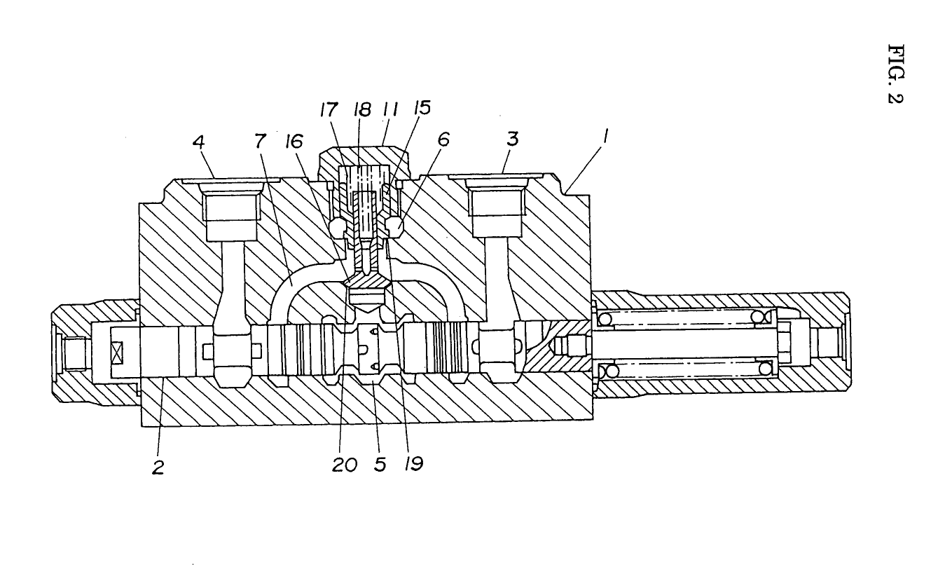

FIG. 2 is a cross-sectional view showing the construction of the second embodiment according to the present invention. In this second embodiment, a second check valve 16 which serves to bring the tandem passage 5 into communication with the communication passage 7 is slidably arranged in a first check valve 15 which serves to bring the parallel passage 6 into the communication passage 7. Further, the first check valve 15 is slidably arranged relative to the inner peripheral portion of the plug 11. In addition, between an inner peripheral portion of the first check valve 15 and an outer peripheral portion of the second check valve 16, a spring 17 is arranged to bias the first check valve 15. In the second check valve 16, a spring 18 is arranged to bias the second check valve 16. The remaining construction is, for example, designed to be equivalent to the corresponding construction of the above-described first embodiment.

When the directional control valve is switched to cause the spool 2 to slide, for example, in a rightward direction of FIG. 2 in the second embodiment, the communication passage 7 and the actuator port 3 are cut off from each other. When pressure fluid is fed from an unillustrated pump to the parallel passage 6 in this state, the first check valve 15 is caused to slide in an upward direction of FIG. 1 against the force of the spring 17, in other words, the first check valve 15 is caused to slide relative to the second check valve 16 and the plug 11. The pressure fluid then flows out from a clearance, which has been formed at the seat portion 19 of the valve main body 1, into the communication passage 7, and further, is fed to the actuator port 4. During this time, the second check valve 16 remains pressed against the seat portion 20 of the valve main body 1 by the pressure fluid fed into the communication passage 7. Accordingly, the tandem passage 5 remains closed.

When the pressure fluid is fed to the tandem passage 5 in the state that the spool 2 has been caused to slide in the rightward direction as mentioned above, the second check valve 16 is caused to slide relative to the first check valve 15 against the force of the spring 18 and hence, to move upwards in FIG. 2. Therefore, the pressure fluid in the tandem passage 5 flows out from a clearance, which has been formed at the seat portion 20 of the valve main body 1, into the communication passage 7, and further, is fed to the actuator port 4.

Operations substantially similar to those mentioned above are also performed when the directional control valve is switched to cause the spool 1 to slide in a leftward direction of FIG. 2.

According to the second embodiment constructed as described above, the first check valve 15 and second check valve 16 can be arranged in the valve main body 1 without needing such guide pipes as arranged in the conventional technology. The second embodiment can, therefore, bring about substantially the same advantageous effects as the above-described first embodiment.

1. A directional control valve block comprising plural directional control valves in a valve main body, each of said directional control valves being provided with a slidable spool, a pair of actuator ports, a communication passage communicable to said actuator ports, a parallel passage connecting said plural directional control valves in parallel with each other, a tandem passage connecting said plural directional control valves in series with each other, a first check valve for permitting a flow of pressure fluid from said parallel passage toward said communication passage and preventing any flow of pressure fluid in an opposite direction, and a second check valve arranged coaxially with said first check valve for permitting a flow of pressure fluid from said tandem passage toward said communication passage and preventing any flow of pressure fluid in an opposite direction, characterized in that:
one of said first check valve and said second check valve is slidably arranged in the other, a plug is arranged in threaded engagement with said valve main body such that an end portion of said first check valve and an end portion of said second check valve are covered by said plug, and a spring is arranged between at least one of said first check valve and second check valve and said plug such that said first check valve and said second check valve are biased in closing directions.

2. A directional control valve block according to claim 1, wherein:
said first check valve is slidably arranged in said second check valve, and said second check valve is provided with a through-hole formed in communication with said communication passage.

3. A directional control valve block according to claim 2, wherein:
said second check valve is internally provided with a seat portion with which said first check valve is normally maintained in contact.

4. A directional control valve block according to claim 1, wherein:
said second check valve is slidably arranged in said first check valve.

5. A directional control valve block according to claim 4, wherein:
a spring is arranged between said plug and said first check valve such that said first check valve is biased in an closing direction, a spring is arranged between said plug and said second check valve such that said second check valve is biased in a closing direction, and a seat portion is arranged in said parallel passage such that said first check valve is normally maintained in contact with said seat portion.
